(19) United States
(12) Patent Application Publication
(10) Pub. No.: US 2026/0006393 A1
(43) Pub. Date: Jan. 1, 2026

(54) RENDERING OF OCCLUDED AUDIO ELEMENTS

(71) Applicant: Telefonaktiebolaget LM Ericsson (publ), Stockholm (SE)

(72) Inventor: Tommy FALK, SPÅNGA (SE)

(73) Assignee: Telefonaktiebolaget LM Ericsson (publ), Stockholm (SE)

(21) Appl. No.: 18/993,119

(22) PCT Filed: Jul. 3, 2023
(86) PCT No.: PCT/EP2023/068137

§ 371 Date: Jan. 10, 2025

Related U.S. Application Data
(60) Provisional application No. 63/388,685, filed on Jul. 13, 2022.

(51) Int. Cl. H04S 7/00

(52) U.S. Cl. CPC H04S 7/302

(57) ABSTRACT

A method for rendering an audio element associated with a first extent. In one embodiment, the method includes determining a first point within the first extent, wherein the first point is not completely occluded. The method also includes determining a second extent for the audio element, wherein the determining comprises using the first point to determine a first edge of the second extent. The method also includes, after determining the second extent, dividing the second extent into a set of one or more sub-areas, the set of sub-areas comprising at least a first sub-area. The method also includes determining a first gain value for a first sample point of the first sub-area. The method further includes using the first gain value to render the audio element (e.g., generate an output signal using the first gain value).

### TECHNICAL FIELD

Disclosed are embodiments related to rendering of occluded audio elements.

### BACKGROUND

Spatial audio rendering is a process used for presenting audio within an extended reality (XR) scene (e.g., a virtual reality (VR), augmented reality (AR), or mixed reality (MR) scene) in order to give a listener the impression that sound is coming from physical sources within the scene at a certain position and having a certain size and shape (i.e., extent). The presentation can be made through headphone speakers or other speakers. If the presentation is made via headphone speakers, the processing used is called binaural rendering and uses spatial cues of human spatial hearing that make it possible to determine from which direction sounds are coming. The cues involve inter-aural time delay (ITD), inter-aural level difference (ILD), and/or spectral difference.

The most common form of spatial audio rendering is based on the concept of point-sources, where each sound source is defined to emanate sound from one specific point. Because each sound source is defined to emanate sound from one specific point, the sound source doesn't have any size or shape. In order to render a sound source having an extent (size and shape), different methods have been developed.

One such known method is to create multiple copies of a mono audio element at positions around the audio element. This arrangement creates the perception of a spatially homogeneous object with a certain size. This concept is used, for example, in the “object spread” and “object divergence” features of the MPEG-H 3D Audio standard (see references [1] and [2]), and in the “object divergence” feature of the EBU Audio Definition Model (ADM) standard (see reference [4]). This idea using a mono audio source has been developed further as described in reference [7], where the area-volumetric geometry of a sound object is projected onto a sphere around the listener and the sound is rendered to the listener using a pair of head-related (HR) filters that is evaluated as the integral of all HR filters covering the geometric projection of the object on the sphere. For a spherical volumetric source this integral has an analytical solution. For an arbitrary area-volumetric source geometry, however, the integral is evaluated by sampling the projected source surface on the sphere using what is called a Monte Carlo ray sampling.

Another rendering method renders a spatially diffuse component in addition to a mono audio signal, which creates the perception of a somewhat diffuse object that, in contrast to the original mono audio element, has no distinct pin-point location. This concept is used, for example, in the “object diffuseness” feature of the MPEG-H 3D Audio standard (see reference [3]) and the “object diffuseness” feature of the EBU ADM (see reference [5]).

Combinations of the above two methods are also known. For example, the “object extent” feature of the EBU ADM combines the creation of multiple copies of a mono audio element with the addition of diffuse components (see reference [6]).

In many cases the actual shape of an audio element can be described well enough with a basic shape (e.g., a sphere or a box). But sometimes the actual shape is more complicated and needs to be described in a more detailed form (e.g., a mesh structure or a parametric description format).

In the case of heterogeneous audio elements, as are described in reference [8], the audio element comprises at least two audio channels (i.e., audio signals) to describe a spatial variation over its extent.

In some XR scenes there may be an object that blocks at least part of an audio element in the XR scene. In such a scenario the audio element is said to be at least partially occluded.

That is, occlusion happens when, from the viewpoint of a listener (e.g. human listener) at a given listening position, an audio object is completely or partly hidden behind some object such that no or less direct sound from the occluded part of the object reaches the listener. Depending on the material of the occluding object, the occlusion effect might be either complete occlusion (e.g., when the occluding object is a thick wall) or non-complete occlusion (e.g., when the occluding object is made of thin fabric such as a curtain) (a.k.a., “soft” occlusion). Soft occlusion can often be well described by a filter with a certain frequency response that matches the acoustic characteristics of the material of the occluding object.

### SUMMARY

Certain challenges presently exist. For example, available occlusion rendering techniques deal with point sources where the occurrence of occlusion can be detected easily using raytracing between the listener position and the position of the point source, but for an audio element with an extent, the situation is more complicated since an occluding object may occlude only a part of the extent of the audio element. To get a good enough resolution of the occlusion effect, a large number of rays may need to be cast towards the extent, which will add a considerable amount of processing complexity to the rendering of the audio object.

Accordingly, in one aspect there is provided an improved method for rendering an audio element associated with a first extent. In one embodiment, the method includes determining a first point within the first extent, wherein the first point is not completely occluded. The method also includes determining a second extent for the audio element, wherein the determining comprises using the first point to determine a first edge of the second extent. The method also includes, after determining the second extent, dividing the second extent into a set of one or more sub-areas, the set of sub-areas comprising at least a first sub-area. The method also includes determining a first gain value for a first sample point of the first sub-area. The method further includes using the first gain value to render the audio element (e.g., generate an output signal using the first gain value).

In another aspect there is provided a computer program comprising instructions which when executed by processing circuitry of an audio renderer causes the audio renderer to perform the methods disclosed herein. In one embodiment, there is provided a carrier containing the computer program wherein the carrier is one of an electronic signal, an optical signal, a radio signal, and a computer readable storage medium. In another aspect there is provided a rendering apparatus that is configured to perform the methods disclosed herein. The rendering apparatus may include memory and processing circuitry coupled to the memory.

An advantage of the embodiments disclosed herein is that they make it possible to detect the occlusion over an extent with good precision using a limited number of ray casts.

### BRIEF DESCRIPTION OF THE DRAWINGS

The accompanying drawings, which are incorporated herein and form part of the specification, illustrate various embodiments.

FIG. 1 shows two point sources (S1 and S2) and an occluding object (O).

FIG. 2 shows an audio element having an extent being partially occluded by an occluding object.

FIG. 3. illustrates a process for determining an edge of a modified extent.

FIG. 4 illustrates a modified extent.

FIG. 5 illustrates an audio element for which no edge of the element's extent is completely occluded.

FIG. 6A illustrates the effect of a moving occluding object when detection of occlusion is be made with a uniform grid of ray casts.

FIG. 6B illustrates the effect of a moving occluding object when detection of occlusion is be made with a uniform grid of ray casts.

FIG. 7A illustrates the effect of a moving occluding object when detection of occlusion is be made with a skewed grid of ray casts.

FIG. 7B illustrates the effect of a moving occluding object when detection of occlusion is be made with a skewed grid of ray casts.

FIG. 8 is a flowchart illustrating a process according to an embodiment.

FIG. 9A shows a system according to some embodiments.

FIG. 9B shows a system according to some embodiments.

FIG. 10 illustrates a system according to some embodiments.

FIG. 11. illustrates a signal modifier according to an embodiment.

FIG. 12 is a block diagram of an apparatus according to some embodiments.

### DETAILED DESCRIPTION

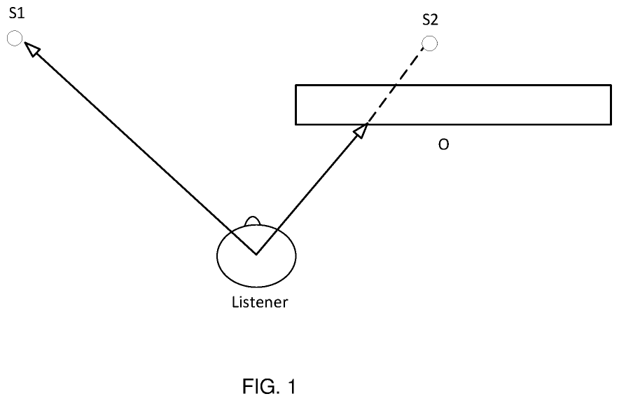

The occurrence of occlusion may be detected using raytracing methods where the direct sound path (or “path” for short) between the listener position and the position of the audio element is searched for any objects occluding the audio element. FIG. 1 shows an example of two point sources (S1 and S2), where one (i.e., S2) is occluded by an object (O) (which is referred to as the “occluding object”) from the listener's perspective and the other (i.e., S1) is not occluded from the listener's perspective. In this case the occluded audio element S2 should be muted in a way that corresponds to the acoustic properties of the material of the occluding object. If the occluding object is a thick wall, the rendering of the direct sounds from the occluded audio element should be more or less completely muted.

For a given frequency range, any given portion of an audio element may be completely occluded, partially occluded, or not occluded. The frequency range may be the entire frequency range that can be perceived by humans or a subset of that frequency range. In one embodiment, a portion of an audio element is completely occluded in a given frequency range when an occlusion gain factor (or “gain” for short) associated with the portion of the audio element satisfies a predefined condition. For example, a portion of an audio element is completely occluded in a given frequency range when an occlusion gain (which may be frequency dependent or not) associated with the portion of the audio element is less than or equal to a threshold gain value (T), where the value T is a selected value (e.g., T=0 is one possibility). That is, for example, any occluding object or objects that let through less than a certain amount of sound is seen as complete occlusion. In another embodiment there is a frequency dependent decision where the amount of occlusion in different frequency bands is compared to a predefined table of thresholds for these frequency bands. Yet another embodiment uses the current signal power of the audio signal representing the audio source and estimates the actual sound power that is let through to the listener, and then compares the sound power to a hearing threshold. In short, a completely occluded audio element (or portion thereof) may be defined as a sound path where the sound is so suppressed that it is not perceptually relevant. This includes the case where the occlusion is completely blocking, i.e., no sound is let through at all, as well as the case where the occluding object(s) only let through a very small amount of the original sound energy such that it is not contributing enough to have a perceptual impact on the total rendering of the audio source.

A portion of an audio element is completely occluded when, for example, there is a “hard” occluding object on the sound path—i.e., a virtual straight line from the listening position to the portion of the audio element. An example of a hard occluding object is a thick brick wall. On the other hand, the portion of the audio element may be partially occluded when, for example, there is a “soft” occluding object on the sound path. An example of a soft occluding object is thin curtain.

If one or several soft occluding objects are in the sound path, the occlusion effect can be calculated as a filter, which corresponds to the audio transmission characteristics of the material. This filter may be specified as a list of frequency ranges and, for each listed frequency range, a corresponding gain. If more than one soft occluding object is in a path, the filters of the materials of those objects can be multiplied together to form one compound filter corresponding to the audio transmission character of that path.

The raytracing can be initiated by specifying a starting point and an endpoint or it can be initiated by specifying a starting point and a direction of the ray in polar format, which means a horizontal and vertical angle plus, optionally a length. The occlusion detection is repeated either regularly in time or whenever there was an update of the scene, so that a renderer has up-to-date occlusion information.

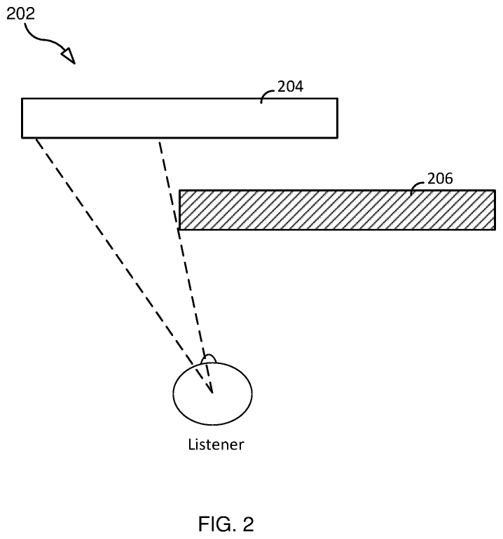

In the case of an audio element 202 with an extent 204, as shown in FIG. 2, the extent of the audio element may be only partly occluded by an occluding object 206. This means that the rendering of the audio element 202 needs to be altered in a way that reflects what part of the extent is occluded and what part is not occluded. The extent 204 may be the actual extent of the audio element 202 as seen from the listener position or a projection of the audio element 202 as seen from the listener position, where the projection may be for example the projection of the extent of the audio element onto a sphere around the listener or a projection of the extent of the audio element onto a plane between the audio element and the listener.

### 1.1. Aspects of Occlusion Detection and Rendering

The process of detecting occlusion of an extent, from the point of view of a listener, will typically involve checking the path between the position of the listener (“listening position”) and each one of a large number of points on the extent for occluding objects. Both the geometry calculations involved in the ray tracing and the calculations of audio transmission filters require some processing, which means that the number these paths (i.e., points on the extent) that are checked should be minimized.

When rendering the effect of occlusion for an audio object with an extent, there are certain aspects that are the perceptually most important. The human auditory system is very good at making out the angle of audio objects in the horizontal plane, often referred to as the azimuth angle, since we can make use of the timing differences between the sound that reaches the right and left ear respectively. Under ideal circumstances humans can discern a difference in horizontal angle of only 1°. For the vertical angle, often referred to as the elevation angle, there are no timing differences that can help the auditory system. Instead, the only cues that our spatial hearing uses to differentiate between different vertical angles is the difference in frequency response that comes from the filtering from our ears, which is different for different vertical angles. Hence the accuracy of the vertical angle is perceptually less important than the horizontal angle.

Even though the vertical position of the top and bottom edge of an extent may not be perceptually critical, the detection of these edges can also affect the overall energy of the audio object. The required resolution due to the change in energy may be higher than due to the perceived change in spatial position.

For an audio object with an extent, the outer edges are the most prominent features, but the energy distribution over the extent also needs to be reflected reasonably well. It is important that changes of positions, energy, or filtering are smooth and does not change in discrete steps, unless there is a sudden movement of the audio source, listener, or some occlude (or any combination thereof).

The most straight-forward way to avoid stepwise changes in the occlusion detection is to use a large number of ray casts, so that smooth changes in occlusion can be tracked with a high resolution. This can make the steps small enough that they are not perceivable. However, a large number of ray casts will add considerably to the complexity of the algorithm.

Another solution is to add temporal smoothing of the occlusion detection and/or occlusion rendering. This will even out sharp steps and make the occlusion effect behave more smoothly. The downside to this is that the response in the occlusion detection/rendering will be slower and not react directly to fast movements. Typically, a tradeoff is made between the resolution and temporal smoothing, so that the detection and rendering is as fast as possible without generating audible steps.

### 1.2 Occlusion Detection in Two Stages

To achieve a high resolution of the most critical aspects of occlusion detection of an audio source with an extent while minimizing the number of ray casts needed, the process can be done in two stages as follows:

First, detecting so called cropping occlusion, which is occlusion that completely occludes at least one edge of the extent. In case of any cropping occlusion (i.e., an entire edge of the extent is completely occluded), a modified extent is calculated where the completely occluded parts are discarded.

Second, using the modified extent where completely occluded parts have been discarded, measure the amount of occlusion by sending out a set of ray casts (e.g., an even distributed set) and calculate an occlusion filter representing different sub-areas of the modified extent.

The first stage is focused on determining whether an edge of the extent is completely occluded, and if so, determining the corresponding edge for the modified extent (i.e., the edge of occlusion). Here iterative search algorithms can be used to find the edges of occlusion. Since the first stage is only detecting complete occlusion, no occlusion filters need to be calculated for each ray cast. This stage is further described in section 1.3.

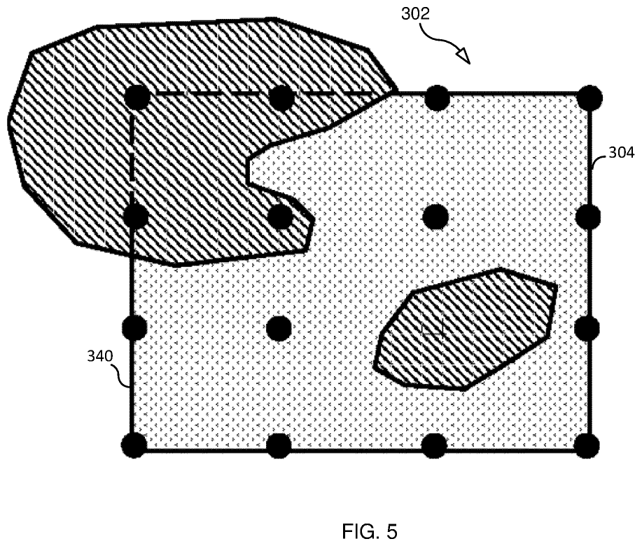

The second stage operates on the modified extent where some completely occluded parts have been discarded. However, it is possible that the “modified” extent is actually not a modified version of the extent but is the same as the extent (this is described further below with respect to FIG. 5). In any event, the focus of this stage is to identify occlusion that happens within the so-called modified extent and calculate occlusion filters that correspond to the occlusion in different sub-areas of the modified extent. This stage is further described in section 1.4.

### 1.3 Optimized Detection of Cropping Occlusion

The detection of cropping occlusion searches for complete occlusion of the edges of the extent of the audio object. Since the auditory system is not well equipped to discern the exact shape of an audio object, this can be simplified into identifying the width and height of the part of the extent that is not completely occluded. This can be done by using an iterative search algorithm, such as a binary search, to find the points on the extent that represents the points with the highest and lowest horizontal angle and highest and lowest vertical angle that are not completely occluded. Using an iterative search algorithm makes it possible to identify the edges of the occlusion with high precision with as few ray casts as possible.

Along with the modified extent, an overall gain factor is calculated that describes the overall gain of the modified extent as compared to the original extent. If a part of the original extent is occluded, that should be reflected in the overall gain of the rendered audio element. The overall gain factor, gov, can be calculated as

$${g}_{OV} = \sqrt{\frac{{A}_{MOD}}{{A}_{ORG}}}$$

where A_{MOD} is the area of the modified extent and A_{ORG} is the area of the original extent. This is assuming that the audio element can be seen as a diffuse source. If the source is to be seen as a coherent source the gain can be calculated as

$${g}_{OV} = \frac{{A}_{MOD}}{{A}_{ORG}}$$

This overall gain factor should be applied as an overall gain factor when rendering the audio element, either to each sub-area, or to each virtual loudspeaker that is used to render the audio element. Since this stage is only detecting complete occlusion, the gain is valid for the whole frequency range.

The detection of cropping occlusion may start with casting a sparse grid of rays towards the extent to get a first, rough estimate of the edges. The points representing the highest and lowest horizontal and vertical angles, that are not completely occluded, are stored as starting points for iterative searches where the exact edges are found.

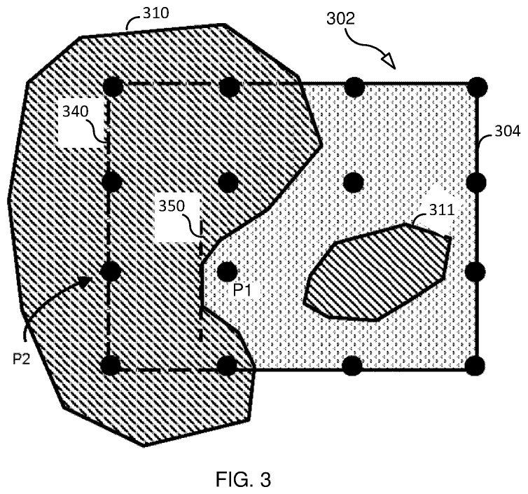

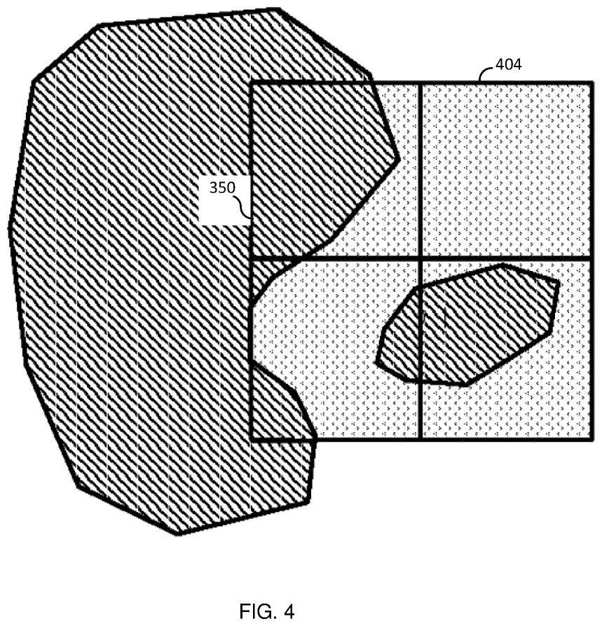

FIG. 3 shows an example where an extent 304 (which in this example is a rectangular extent) of an audio element 302 is occluded by occluders 310 and 311. In one embodiment, the occlusion detection is done in two stages. In the first stage cropping occlusion is detected, and a modified extent 404 (see FIG. 4) is determined which, in this example, represents a part of the extent 304 (e.g., a rectangular portion of extent 304). That is, in this example, because an entire edge 340 of extent 304 (i.e., the left edge) was completely occluded, modified extent 404 is smaller than extent 304. More specifically, in this example, modified extent 404 has a different left edge than extent 304, but the right, top, and bottom edges are the same because none of these edges were completely occluded.

Ray tracing positions are visualized as black dots in FIG. 3. In this example, as shown in FIG. 3, the left edge 340 of the extent 304 is completely occluded by object 310. The ray tracing point P1 is the point that represents the left-most point of the extent that is not occluded. Using a binary search between point P1 and P2, an edge of the occlusion 350 can be found. This edge 350 will then be used as the left edge of the modified extent (a.k.a., “cropped extent”) (see, e.g., FIG. 4), which is used by the next stage. Occluder 311 does not occlude any of the edges and does not have any effect on the modified extent.

In one embodiment, after casting a grid of rays towards an extent, the non-occluded point representing the lowest horizontal angle, P1, is stored as min_azimuth_point. In order to find the exact edge of occlusion a binary search can be used. The binary search uses a lower and an upper bound. In this case, the lower bound can be initialized to min_azimuth_point, or P1. The upper bound is initialized to a point with a lower azimuth angle (to the left in this example) which is known to be either occluded or on the edge of the extent. In this case this can be P2. The search will then start by evaluating the occlusion in the point in-between the lower and higher bound. If this middle point is occluded, the higher bound will be set to this middle point. If this middle point is not occluded the lower bound will be set to this middle point. The process can then be repeated until the distance between the lower and higher bound is below a certain threshold, or it can be repeated a N number of times, where N is a predefined configuration value. The middle point between the higher and lower bounds is then used for describing the azimuth angle of the left edge of the modified extent.

FIG. 5 illustrates an example, where none of the edges of extent 304 are completely occluded. Accordingly, in this example, the determined modified extent will be identical to the extent 304.

The cropping occlusion detection will not detect the exact shape of the occlusion, it will only detect a rectangular part of the extent that is not completely occluded, as shown in FIG. 4. This will however cover many typical cases, where the extent is, for example, partly covered by a wall or when seeing/hearing an audio object through a window. One can think of the cropping occlusion stage as a way to define a frame around the part of the extent that is not completely occluded. Within this frame, there might also be partial or soft occlusion happening. Outside of the cropped extent, there is no need to do further checks for occlusion.

For occlusion where the shape of the occluding objects is more complex, or where there is soft occlusion, the second stage will be used to describe the effect of occlusion within the modified extent.

The density of the sparse grid of rays that is used as the starting point for the search of the edges does not directly influence the accuracy of the edge detection. However, the grid of rays needs to be dense enough that it at least detects one point of the extent that is not occluded, which can then be used as the starting point of the iterative search for the edges of the modified extent. There might be situations where most of the extent is occluded and only a small part is not occluded and if the sparse grid does not identify the non-occluded part of the extent, the iterative search cannot be done properly. Sections 1.5 to 1.7 give some examples of how the sampling grids can be optimized so that also small non-occluded parts are detected without making the sample grids very dense.

### 1.4 Optimized Detection of Occlusion Within the Cropped Extent

The second stage of occlusion detection checks for occlusion within the modified (a.k.a., “cropped”) extent, an example of which is shown in FIG. 4.

This is done by, as shown in FIG. 4, dividing the modified extent 404 into one or more sub-areas and calculating an occlusion filter for each sub-area of the modified extent. The occlusion filter for a sub-area describes the amount of occlusion in different frequency bands for the sub-area.

Accordingly, in one embodiment, the modified extent (i.e., extent 304 or 404) is divided into a number of sub-areas. The number of sub-areas may vary and even be adaptive, depending on, for example, the size of the extent. Typically, the number of sub-areas needed is related to how the extent is later rendered. If the rendering is based on virtual loudspeakers and the number of virtual loudspeakers is low, then there is little need to have many sub-areas since they will anyway be rendered using a virtual speaker setup with limited spatial resolution. If the extent is very small, no divisioning may be needed and then only one sub-area is defined, which will be equal to the entire modified extent.

Examples of typical sub-area divisions for different numbers of sub-areas are given below:
One sub-area: no division;
Two sub-areas: left, right;
Three sub-areas: left, center, right;
Four sub-areas: top-left, top-right, bottom-left, bottom-right;
Five sub-areas: top-left, top-right, center, bottom-left, bottom-right; and
Six sub-areas: top-left, top-center, top-right, bottom-left, bottom-center, bottom-right.

The sub-areas do not necessarily need to be the same size, but the rendering will be simplified if this is the case because the energy contribution of each sub-area is then the same.

For each sub-area, a set of rays are cast to get an estimate of how much occlusion there is for this particular part of the modified extent. For each ray cast, an occlusion filter is formed from the acoustic transmission parameters of any material that the ray passed through. The filter can be expressed as a list of gain factors for different frequency bands. For the case where the ray passes through more than one occluder, the occlusion filter is calculated by multiplying the gain of the different materials at each frequency band. If a ray is completely occluded, the occlusion filter can be set to 0.0 for all frequencies. If the ray does not pass through any occluding objects, the occlusion filter can be counted as having gain 1.0 for all frequencies. If a ray does not hit the extent of the audio object, it can be handled as a completely occluded ray or just be discarded.

For each sub-area, the occlusion filters of every ray cast are accumulated to form one occlusion filter that represents the occlusion within that sub-area. The accumulated gain per frequency band for that sub-area can then be calculated for example using:

$${G}_{SA , f} = \sqrt{\frac{{\sum }_{0}^{N} {g}_{n , f}}{N}}$$

where G_{SA,ƒ} denotes the accumulated gain for frequency ƒ from one sub-area, g_{n,ƒ} is the gain for frequency ƒ and one sample point in the sub-area and N is the number of sample points. This assumes that the audio source can be seen as a diffuse source. If the source is to be seen as a coherent source, the gains of each sample point are added together linearly according to:

$${G}_{SA , f} = \frac{{\sum }_{0}^{N} {g}_{n , f}}{N}$$

For a specific example, assume that two rays are cast towards a sub-area of the extent and the first ray passes through a thin occluding object made of a first material (e.g., cotton) and the second ray passes through a thick occluding object made of a second material (e.g., brick). That is, the point within the extent through which the first ray passes is occluded by the thin occluding object and the point within the extent through which the second ray passes is occluded by the thick occluding object. Assume also that each material is associated with a different filter (i.e., a set of frequency ranges and a gain factor for each frequency range) as illustrated in the table below:

TABLE 1

| | F1 | F2 | F3 |
|---|---|---|---|
| Material 1 | g11 | g12 | g13 |
| Material 2 | g21 | g22 | g23 |

In this example, G_{SA,F1}=sqrt((g11+g21)/2); G_{SA,F2}=sqrt((g12+g22)/2); and G_{SA,F3}=sqrt((g13+g23)/2). That is, the sub-area is associated with three different accumulated gain values (G_{SA,F1}, G_{SA,F2}, G_{SA,F3}), one for each frequency (or frequency range).

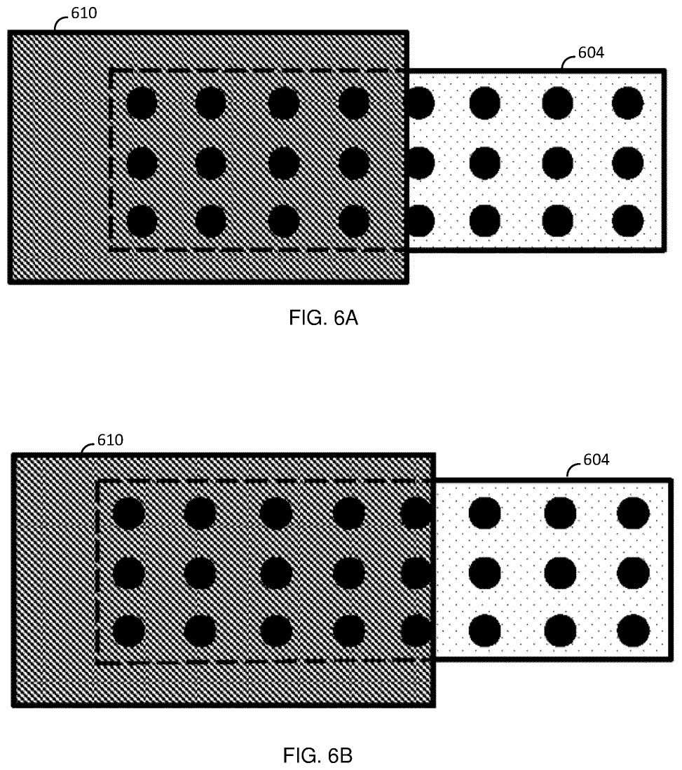

The distribution pattern of the rays over each sub-area should preferably be even. The simplest form of even distribution pattern would be a regular grid. But a regular grid pattern would mean that many sample points will be made with the same horizontal angle and many sample points with the same vertical angle. Since many occlusion situations involve occluders that have straight vertical or horizontal edges, such as wall, doorways, windows etc., this may increase the problem with stepwise behavior. This problem is illustrated in FIG. 6A and FIG. 6B.

FIG. 6A and FIG. 6B show an example of occlusion detection using 24 rays in an even grid. The extent 604 is shown as seen from the listening position and an occluder 610 is moving from the left to the right covering more and more of the extent. In FIG. 6A, the occluder 610 blocks 12 of the rays (the rays are visualized as black dots). In FIG. 6B, the occluder has moved further to the right and is now blocking 15 of the rays. As the occluder moves further the amount of occlusion will change in discrete steps, which would cause audible instant changes in audio level.

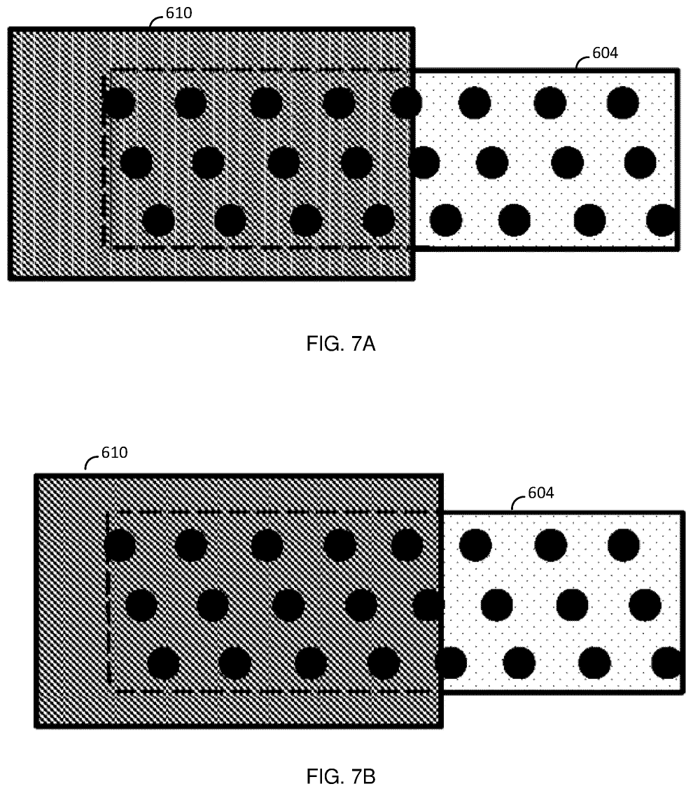

Instead of using a regular grid as shown in FIG. 6A and FIG. 6B, some form of random sampling distribution could be used, such as completely random sampling, clustered random sampling, or regular sampling with a random offset. Generally, a good distribution pattern is one where the sample points are not repeating the same vertical or horizontal angles. Such a pattern can be constructed from a regular grid where an increasing offset is added to the vertical position of samples within each horizontal row and where an increasing offset is added to the horizontal position of samples within each vertical column. Such a skewed grid pattern will distribute the sampling points so that the horizontal and vertical positions of all sampling points are as evenly distributed as possible. FIG. 7A and FIG. 7B show an example of a grid where an increasing offset is added to the horizontal positions of the sample points. As can be seen, only one extra ray is occluded when the occluder has moved. This means that the resolution of the detection has been increased by a factor of three compared to the example with a regular grid as shown in FIG. 6A and FIG. 6B using the same number of sampling points.

### 1.5 Time Varying Ray Cast Sampling Grids

The number of ray casts used for the two stages of detection can be adaptive. For example, the number of ray casts can be adapted so that the resolution is kept constant regardless of the size of the extent or the number of rays can be made dependent on the current renderer load so that fewer rays are used when there is a lot of other processing active in the renderer.

Another way to vary the number of rays is to make use of previous detection results, so that the resolution is increased for a period of time after some occlusion has been detected. This way a sparser set of rays can be used to detect if there is any occlusion at all and whenever occlusion is detected, the resolution of the next update of the occlusion state can be increased. The increased resolution can then be kept as long as there is still some occlusion detected and then for an extra period of time.

Yet another way to vary the ray cast sampling grid over time is to use a sequence of grids that complement each other so that the spatial resolution can be increased by using the accumulated results of two or more sequential grids. This would mean that the result is averaged over a longer time frame and therefore the response of the occlusion detection would be slower, similar to when applying temporal smoothing. One way to overcome this is to only use sequential grids when there has not been any previous occlusion detected for a period of time and if any occlusion is detected, switch off the sequential grid and instead use one sampling grid with high resolution. Such sequential grids may be pre-calculated or they could be generated on the fly by adding offsets to one predefined grid.

### 1.6 Reusing Ray-Tracing Information From Stage 1 in Stage 2

It is possible to reuse the ray tracing information from stage 1 in stage 2 if the occlusion filters for each ray cast in stage 1 is evaluated and stored so that they can be included in the calculation of the accumulated occlusion filters for each sub-area.

### 1.7 Reusing Occlusion Information From Previous Occlusion Detection Updates

Because scene updates are often smooth, also the change in occlusion is typically gradual. In many cases information from a previous occlusion detection can be used as a good starting point for the next update. One way to make use of previous detections is to add points from within the modified extent of the previous update when doing the first stage detection of cropping occlusion. For example, the center point of the modified extent of the previous occlusion detection update can be added as an extra sample point in the first stage. For example, combining sparse sequential grids of sample points with extra sample points from the previous modified extent can provide a very efficient way of detecting cropping occlusion.

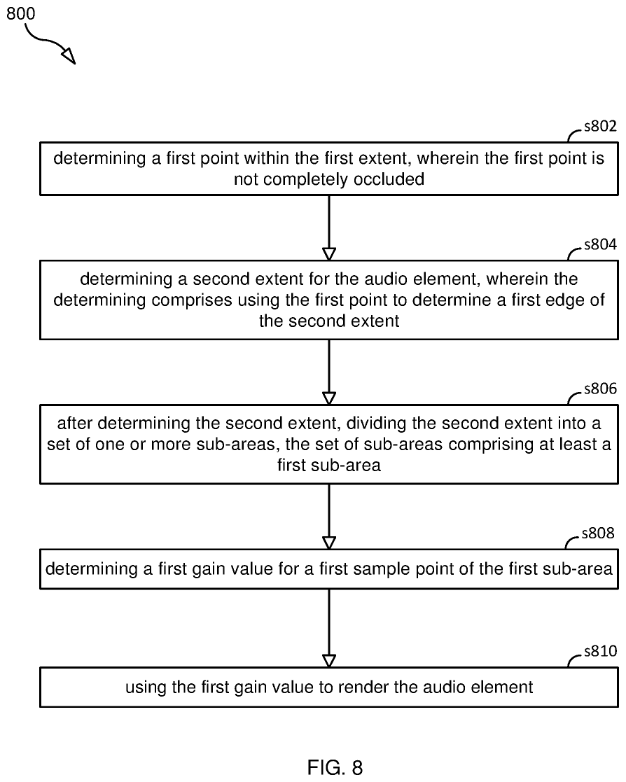

FIG. 8 is a flowchart illustrating a process 800, according to an embodiment, for rendering an audio element associated with a first extent. The first extent may be the actual extent of the audio element as seen from the listener position or a projection of the audio element as seen from the listener position, where the projection may be for example the projection of the extent of the audio element onto a sphere around the listener or a projection of the extent of the audio element onto a plane between the audio element and the listener. International Patent Application Publication No. WO2021180820 describes a technique for projecting an audio object with a complex shape. For example the publication describes a method for representing an audio object with respect to a listening position of a listener in an extended reality scene, where the method includes: obtaining first metadata describing a first three-dimensional (3D) shape associated with the audio object and transforming the obtained first metadata to produce transformed metadata describing a two-dimensional (2D) plane or a one-dimensional (1D) line, wherein the 2D plane or the 1D line represent at least a portion of the audio object, and transforming the obtained first metadata to produce the transformed metadata comprises: determining a set of description points, wherein the set of description points comprises an anchor point; and determining the 2D plane or 1D line using the description points, wherein the 2D plane or 1D lines passes through the anchor point. The anchor point may be: i) a point on the surface of the 3D shape that is closest to the listening position of the listener in the extended reality scene, ii) a spatial average of points on or within the 3D shape, or iii) the centroid of the part of the shape that is visible to the listener; and the set of description points further comprises: a first point on the first 3D shape that represents a first edge of the first 3D shape with respect to the listening position of the listener, and a second point on the first 3D shape that represents a second edge of the first 3D shape with respect to the listening position of the listener.

Process 800 may begin in step s802. Step s802 comprises determining a first point within the first extent, wherein the first point is not completely occluded. This step corresponds to a step within the first stage of the above described two stage process and the first point can correspond to point P1 in FIG. 3.

Step s804 comprises determining a second extent (referred to above as the modified extent) for the audio element, wherein the determining comprises using the first point to determine a first edge of the second extent. This step is also a step within the first stage described above. The first edge of the second extent may be edge 350 in the case that edge 340 is completely occluded, as shown in FIG. 3, or edge 340 in the event that edge 340 is not completely occluded as shown in FIG. 5.

Step s806 comprises, after determining the second extent, dividing the second extent into a set of one or more sub-areas, the set of sub-areas comprising at least a first sub-area.

Step s808 comprises determining a first gain value (e.g., for a first frequency) for a first sample point of the first sub-area.

Step s810 comprises using the first gain value to render the audio element (e.g., generate an output signal using the first gain value).

### Example Use Case

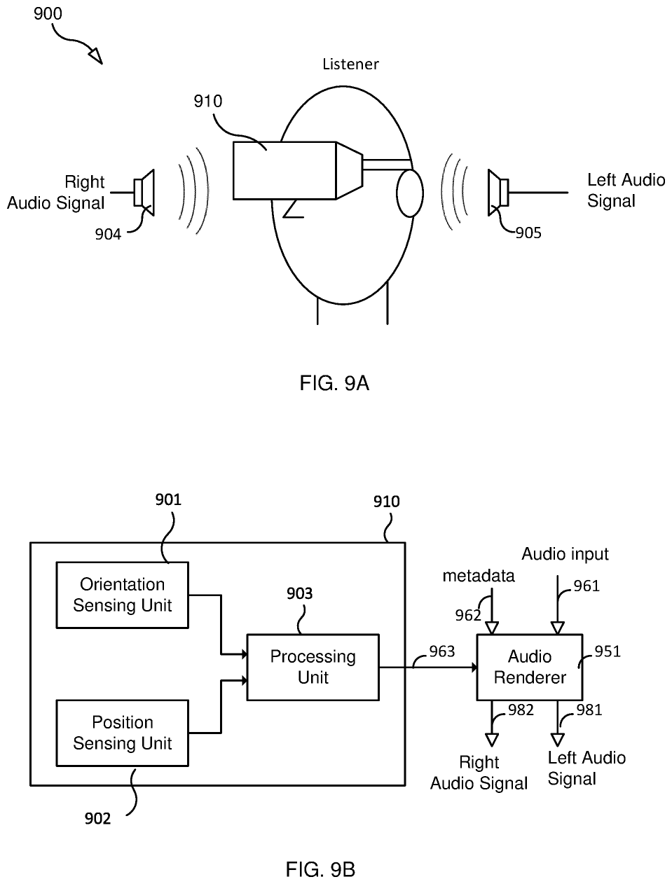

FIG. 9A illustrates an XR system 900 in which the embodiments may be applied. XR system 900 includes speakers 904 and 905 (which may be speakers of headphones worn by the listener) and a display device 910 that is configured to be worn by the listener. As shown in FIG. 9B, XR system 910 may comprise an orientation sensing unit 901, a position sensing unit 902, and a processing unit 903 coupled (directly or indirectly) to an audio render 951 for producing output audio signals (e.g., a left audio signal 981 for a left speaker and a right audio signal 982 for a right speaker as shown). Audio renderer 951 produces the output signals based on input audio signals, metadata regarding the XR scene the listener is experiencing, and information about the location and orientation of the listener. The metadata for the XR scene may include metadata for each object and audio element included in the XR scene, and the metadata for an object may include information about the dimensions of the object and the occlusion gains for the object (e.g., the metadata may specify a set of occlusion gains (or a set of occlusion factors from which the occlusion gains can be derived) where each occlusion gain is applicable for a different frequency or frequency range). Audio renderer 951 may be a component of display device 910 or it may be remote from the listener (e.g., renderer 951 may be implemented in the “cloud”).

Orientation sensing unit 901 is configured to detect a change in the orientation of the listener and provides information regarding the detected change to processing unit 903. In some embodiments, processing unit 903 determines the absolute orientation (in relation to some coordinate system) given the detected change in orientation detected by orientation sensing unit 901. There could also be different systems for determination of orientation and position, e.g. a system using lighthouse trackers (lidar). In one embodiment, orientation sensing unit 901 may determine the absolute orientation (in relation to some coordinate system) given the detected change in orientation. In this case the processing unit 903 may simply multiplex the absolute orientation data from orientation sensing unit 901 and positional data from position sensing unit 902. In some embodiments, orientation sensing unit 901 may comprise one or more accelerometers and/or one or more gyroscopes.

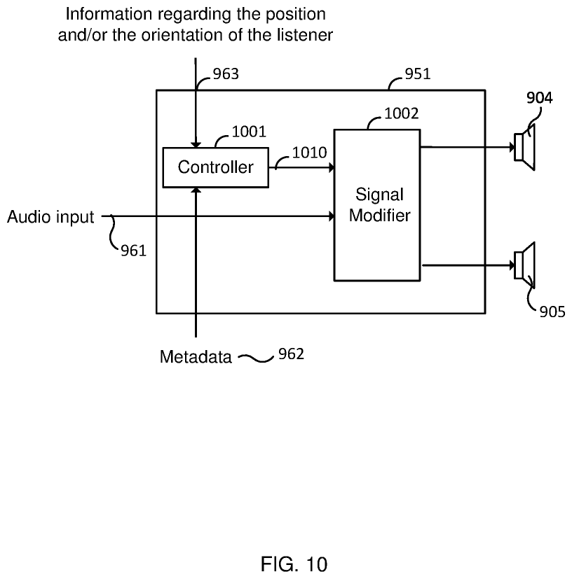

FIG. 10 shows an example implementation of audio renderer 951 for producing sound for the XR scene. Audio renderer 951 includes a controller 1001 and a signal modifier 1002 for modifying audio signal(s) 961 (e.g., the audio signals of a multi-channel audio element) based on control information 1010 from controller 1001. Controller 1001 may be configured to receive one or more parameters and to trigger modifier 1002 to perform modifications on audio signals 961 based on the received parameters (e.g., increasing or decreasing the volume level). The received parameters include information 963 regarding the position and/or orientation of the listener (e.g., direction and distance to an audio element), metadata 962 regarding an audio element in the XR scene (e.g., audio element 602), and metadata regarding an object occluding the audio element (in some embodiments, controller 1001 itself produces the metadata 962). Using the metadata and position/orientation information, controller 1001 may calculate one more gain factors (g) (e.g., the overall gain factor and the accumulated gains per sub-area) for an audio element in the XR scene that is at least partially occluded as described above.

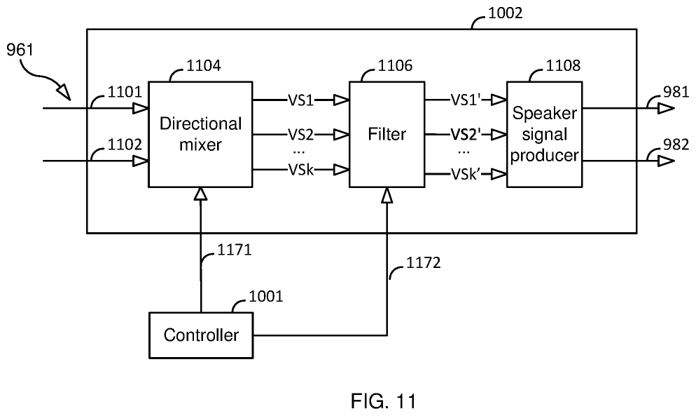

FIG. 11 shows an example implementation of signal modifier 1002 according to one embodiment. Signal modifier 1002 includes a directional mixer 1104, a filter 1106, and a speaker signal producer 1108.

Directional mixer 1104 receives audio input 961, which in this example includes a pair of audio signals 1101 and 1102 associated with an audio element, and produces a set of k virtual loudspeaker signals (VS1, VS2, . . . , VSk) based on the audio input and control information 1171. In one embodiment, the signal for each virtual loudspeaker can be derived by, for example, the appropriate mixing of the signals that comprise the audio input 961. For example: VS1=α×L+β×R, where L is input audio signal 1101, R is input audio signal 1102, and a and B are factors that are dependent on, for example, the position of the listener relative to the audio element and the position of the virtual loudspeaker to which VS1 corresponds.

In the example where an audio element is associated with three virtual loudspeakers (SpL, SpC, and SpR), then k will equal 3 for the audio element and VS1 may correspond to SpL, VS2 may correspond to SpC, and VS3 may correspond to SpR. The control information 1171 used by directional mixer to produce the virtual loudspeaker signals may include the positions of each virtual loudspeaker relative to the audio element. In some embodiments, controller 1001 is configured such that, when the audio element is occluded, controller 1001 may adjust the position of one or more of the virtual loudspeakers associated with the audio element and provide the position information to directional mixer 1104 which then uses the updated position information to produce the signals for the virtual loudspeakers (i.e., VS1, VS2, . . . , VSk).

Filter 1106 may adjust the gain of any one or more of the virtual loudspeaker signals based on control information 1172, which may include the above described accumulated gain factors and overall gain factor as calculated by controller 1001. That is, for example, when the audio element is at least partially occluded, controller 1001 may control filter 1106 to adjust the gain of one or more of the virtual loudspeaker signals by providing one or more gain factors to filter 1106. For instance, if the entire left portion of the audio element is occluded, then controller 1001 may provide to filter 1106 control information 1172 that causes filter 1106 to reduce the gain of VS1 by 100% (i.e., gain factor=0 so that VS1′ =0). As another example, if only 50% of the left portion of the audio element is occluded and 0% of the center portion is occluded, then controller 1001 may provide to filter 1106 control information 1172 that causes filter 1106 to reduce the gain of VS1 by 50% (i.e., VS1′=50% VS1) and to not reduce the gain of VS2 at all (i.e., gain factor=1 so that VS2′=VS2). As another example, assume that VS1 is the signal associated with a specific sub-area, the accumulated gain for this sub-area is g_{SA1}, and the overall gain is gov, then, in one embodiment VS1′=VS1×g_{SA1}×gov.

Using virtual loudspeaker signals VS1′, VS2′, . . . , VSk′, speaker signal producer 1108 produces output signals (e.g., output signal 981 and output signal 982) for driving speakers (e.g., headphone speakers or other speakers). In one embodiment where the speakers are headphone speakers, speaker signal producer 1108 may perform conventional binaural rendering to produce the output signals. In embodiments where the speakers are not headphone speakers, speaker signal producer 1108 may perform conventional speaking panning to produce the output signals.

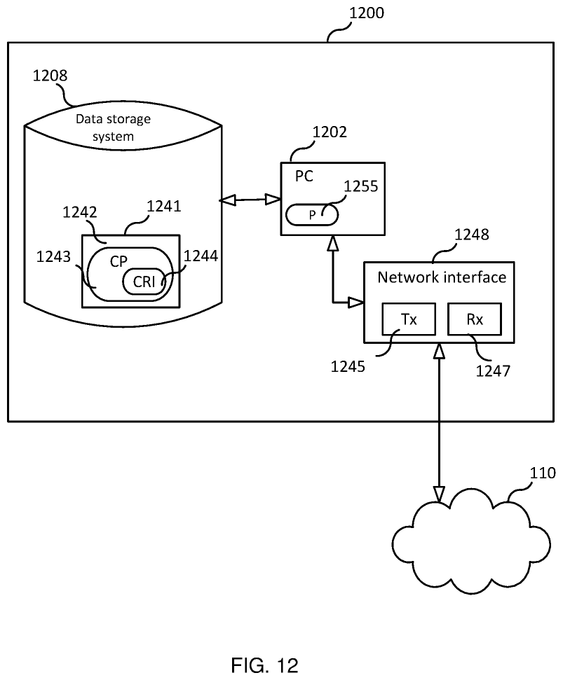

FIG. 12 is a block diagram of an audio rendering apparatus 1200, according to some embodiments, for performing the methods disclosed herein (e.g., audio renderer 951 may be implemented using audio rendering apparatus 1200). As shown in FIG. 12, audio rendering apparatus 1200 may comprise: processing circuitry (PC) 1202, which may include one or more processors (P) 1255 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 1200 may be a distributed computing apparatus); at least one network interface 1248 comprising a transmitter (Tx) 1245 and a receiver (Rx) 1247 for enabling apparatus 1200 to transmit data to and receive data from other nodes connected to a network 110 (e.g., an Internet Protocol (IP) network) to which network interface 1248 is connected (directly or indirectly) (e.g., network interface 1248 may be wirelessly connected to the network 110, in which case network interface 1248 is connected to an antenna arrangement); and a storage unit (a.k.a., “data storage system”) 1208, which may include one or more non-volatile storage devices and/or one or more volatile storage devices. In embodiments where PC 1202 includes a programmable processor, a computer program product (CPP) 1241 may be provided. CPP 1241 includes a computer readable medium (CRM) 1242 storing a computer program (CP) 1243 comprising computer readable instructions (CRI) 1244. CRM 1242 may be a non-transitory computer readable medium, such as, magnetic media (e.g., a hard disk), optical media, memory devices (e.g., random access memory, flash memory), and the like. In some embodiments, the CRI 1244 of computer program 1243 is configured such that when executed by PC 1202, the CRI causes audio rendering apparatus 1200 to perform steps described herein (e.g., steps described herein with reference to the flow charts). In other embodiments, audio rendering apparatus 1200 may be configured to perform steps described herein without the need for code. That is, for example, PC 1202 may consist merely of one or more ASICs. Hence, the features of the embodiments described herein may be implemented in hardware and/or software.

### Summary of Various Embodiments

A1. A method 800 for rendering an audio element 302 associated with a first extent 304, the method comprising: determining s802 a first point (e.g., P1) within the first extent, wherein the first point is not completely occluded; determining s804 a second extent 304, 404 for the audio element, wherein the determining comprises using the first point to determine a first edge of the second extent; after determining the second extent, dividing s806 the second extent into a set of one or more sub-areas, the set of sub-areas comprising at least a first sub-area; determining s808 a first gain value for a first sample point of the first sub-area; using s810 the first gain value to render the audio element (e.g., generate an output signal using the first gain value).
A2. The method of embodiment A1, wherein determining the first edge of the second extent using the first point comprises determining whether the first point is on a first edge of the first extent or within a threshold distance of the first edge of the first extent.
A3. The method of embodiment A2, wherein determining the first edge of the second extent further comprises setting the first edge of the second extent equal to the first edge of the first extent as a result of determining that the first point is on the first edge of the first extent or within the threshold distance of the first edge of the first extent.
A4. The method of embodiment A2, wherein determining the first edge of the second extent comprises: determining a third point between the first point and a second point within the first extent, wherein the second point is completely occluded; and determining whether the third point is completely occluded or using the third point to define the first edge of the second extent.
A5. The method of embodiment A4, wherein determining the first edge of the second extent further comprises: determining whether the third point is completely occluded; and determining a fourth point between the first point and the third point if it is determined that the third point is completely occluded; or determining a fourth point between the second point and the third point if it is determined that the third point is not completely occluded.
A6. The method of embodiment A5, wherein determining the first edge of the second extent using the first point further comprises: using the fourth point to define the first edge of the second extent.
A7. The method of any one of embodiments A1-A6, wherein determining the second extent further comprises: determining a fifth point within the first extent, wherein the fifth point is not completely occluded; and using a fifth point to determine a second edge of the second extent.
A8. The method of embodiment A7, wherein determining the second edge of the second extent using the fifth point comprises determining whether the fifth point is on a second edge of the first extent or within a threshold distance of the second edge of the first extent.
A9. The method of embodiment A8, wherein determining the second edge of the second extent comprises setting the second edge of the second extent equal to the second edge of the first extent as a result of determining that the fifth point is on the second edge of the first extent or within the threshold distance of the second edge of the first extent.
A10. The method of any one of embodiments A1-A9, wherein determining the first gain value for the first sample point of the first sub-area comprises: for a virtual straight line extending from a listening position to the first sample point, determining whether the virtual line passes through one or more objects.
A11. The method of embodiment A10, wherein the virtual line passes through at least a first object, and the step of determining the first gain value for the first sample point of the first sub-area further comprises: obtaining first metadata associated with the first object; and determining the first gain value using the first metadata.
A12. The method of embodiment A11, wherein the virtual line further passes through a second object, and the step of determining the first gain value for the first sample point of the first sub-area further comprises: obtaining second metadata associated with the second object; and determining the first gain value further using the second metadata.
A13. The method of any one of embodiments A1-A12, wherein using the first gain value to render the audio element comprises using the first gain value to calculate a first accumulated gain value for the first sub-area and using the first accumulated gain value to render the audio element.
A14. The method of embodiment A13, wherein using the first accumulated gain value to render the audio element comprises modifying an audio signal associated with the first sub-area based on the first accumulated gain value to produce a modified audio signal and rendering the audio element using the modified audio signal.
A15. The method of any one of embodiments A1-A14, wherein determining the first gain value for the first sample point of the first sub-area comprises: casting a skewed grid of rays towards the first sub-area, wherein one of the rays intersects the sub-area at the first sample point.
A16. The method of any one of embodiments A1-A15, further comprising calculating an overall gain factor, gov, wherein using the first gain value to render the audio element comprises using the first gain value and gov to render the audio element.
A17. The method of embodiment 16, wherein the first extent has a first area, A1, the second extent has a second area, A2, wherein A2<A1, and calculating gov comprises calculating A2/A1.
A18. The method of embodiment 17, wherein calculating gov further comprises determining the square root of A2/A1.
B1. A computer program comprising instructions which when executed by processing circuitry of an audio renderer causes the audio renderer to perform the method of any one of embodiments A1-A18.
B2. A carrier containing the computer program of embodiment B1, wherein the carrier is one of an electronic signal, an optical signal, a radio signal, and a computer readable storage medium.
C1. An audio rendering apparatus that is configured to perform the method of any one of embodiments A1-A18.
C2. The audio rendering apparatus of embodiment C1, wherein the audio rendering apparatus comprises memory and processing circuitry coupled to the memory.

While various embodiments are described herein, it should be understood that they have been presented by way of example only, and not limitation. Thus, the breadth and scope of this disclosure should not be limited by any of the above described exemplary embodiments. Moreover, any combination of the above-described objects in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### References

[1] MPEG-H 3D Audio, Clause 8.4.4.7: “Spreading”
[2] MPEG-H 3D Audio, Clause 18.1: “Element Metadata Preprocessing”
[3] MPEG-H 3D Audio, Clause 18.11: “Diffuseness Rendering”
[4] EBU ADM Renderer Tech 3388, Clause 7.3.6: “Divergence”
[5] EBU ADM Renderer Tech 3388, Clause 7.4: “Decorrelation Filters”
[6] EBU ADM Renderer Tech 3388, Clause 7.3.7: “Extent Panner”
[7] Schissler, C., et. al., “Efficient HRTF-based Spatial Audio for Area and Volumetric Sources,” IEEE Transactions on Visualization and Computer Graphics, Vol. 22, No. 4, pp. 1356-1366 April 2016.
[8] Patent Publication WO2020144062, “Efficient spatially-heterogeneous audio elements for Virtual Reality.”
[9] Patent Publication WO2022218986, “RENDERING OF OCCLUDED AUDIO ELEMENTS,” (application no. PCT/EP2022/059762).
[10] Patent Publication WO2021180820, “RENDERING OF AUDIO OBJECTS WITH A COMPLEX SHAPE”.

1. A method for rendering an audio element associated with a first extent, the method comprising:
determining a first point (P1) within the first extent, wherein the first point is not completely occluded;
determining a second extent for the audio element, wherein determining the second extend comprises using the first point to determine a first edge of the second extent;
after determining the second extent, dividing the second extent into a set of one or more sub-areas, the set of sub-areas comprising a first sub-area;
determining a first gain value for a first sample point of the first sub-area; and
using the first gain value to render the audio element.

2. The method of claim 1, wherein determining the first edge of the second extent using the first point comprises determining whether the first point is on a first edge of the first extent or within a threshold distance of the first edge of the first extent.

3. The method of claim 2, wherein determining the first edge of the second extent further comprises setting the first edge of the second extent equal to the first edge of the first extent as a result of determining that the first point is on the first edge of the first extent or within the threshold distance of the first edge of the first extent.

4. The method of claim 2, wherein determining the first edge of the second extent further comprises:
determining a third point between the first point and a second point (P2), wherein the second point is completely occluded; and
determining whether the third point is completely occluded or using the third point to define the first edge of the second extent.

5. The method of claim 4, wherein determining the first edge of the second extent further comprises:
determining whether the third point is completely occluded; and
determining a fourth point between the first point and the third point if it is determined that the third point is completely occluded; or
determining a fourth point between the second point and the third point if it is determined that the third point is not completely occluded.

6. The method of claim 5, wherein determining the first edge of the second extent further comprises:
using the fourth point to define the first edge of the second extent.

7. The method of claim 1, wherein determining the second extent further comprises:
determining a fifth point within the first extent, wherein the fifth point is not completely occluded; and
using a fifth point to determine a second edge of the second extent.

8. The method of claim 7, wherein determining the second edge of the second extent using the fifth point comprises determining whether the fifth point is on a second edge of the first extent or within a threshold distance of the second edge of the first extent.

9. The method of claim 8, wherein determining the second edge of the second extent further comprises setting the second edge of the second extent equal to the second edge of the first extent as a result of determining that the fifth point is on the second edge of the first extent or within the threshold distance of the second edge of the first extent.

10. The method of claim 1, wherein determining the first gain value for the first sample point of the first sub-area comprises:
for a virtual straight line extending from a listening position to the first sample point, determining whether the virtual line passes through one or more objects.

11. The method of claim 10, wherein the virtual line passes through at least a first object, and the step of determining the first gain value for the first sample point of the first sub-area further comprises:
obtaining first metadata associated with the first object; and
determining the first gain value using the first metadata.

12. The method of claim 11, wherein the virtual line further passes through a second object, and the step of determining the first gain value for the first sample point of the first sub-area further comprises:
obtaining second metadata associated with the second object; and
determining the first gain value further using the second metadata.

13. The method of claim 1, wherein using the first gain value to render the audio element comprises using the first gain value to calculate a first accumulated gain value for the first sub-area and using the first accumulated gain value to render the audio element.

14. The method of claim 13, wherein using the first accumulated gain value to render the audio element comprises modifying an audio signal associated with the first sub-area based on the first accumulated gain value to produce a modified audio signal and rendering the audio element using the modified audio signal.

15. The method of claim 1, wherein determining the first gain value for the first sample point of the first sub-area comprises:
casting a skewed grid of rays towards the first sub-area, wherein one of the rays intersects the sub-area at the first sample point.

16. The method of claim 1, further comprising calculating an overall gain factor (gov), wherein using the first gain value to render the audio element comprises using the first gain value and gov to render the audio element.

17. The method of claim 16, wherein
the first extent has a first area (A1),
the second extent has a second area (A2), wherein A2<A1, and
calculating gov comprises calculating A2/A1.

18. The method of claim 17, wherein calculating gov further comprises determining the square root of A2/A1.

19. A computer program comprising instructions which when executed by processing circuitry of an audio rendering apparatus causes the audio rendering apparatus to perform the method of claim 1.

20. (canceled)

21. An audio rendering apparatus for rendering an audio element associated with a first extent, wherein the audio rendering apparatus is configured to perform a method comprising:
determining a first point (P1) within the first extent, wherein the first point is not completely occluded;
determining a second extent for the audio element, wherein determining the second extend comprises using the first point to determine a first edge of the second extent;
after determining the second extent, dividing the second extent into a set of one or more sub-areas, the set of sub-areas comprising a first sub-area;
determining a first gain value for a first sample point of the first sub-area; and
using the first gain value to render the audio element.

22. (canceled)
